(19) United States
(12) Patent Application Publication
(10) Pub. No.: US 2023/0308857 A1
(43) Pub. Date: Sep. 28, 2023

(54) TERMINAL DEVICE AND CHIP

(71) Applicant: RDA Microelectronics (Beijing) Co., Ltd., Beijing (CN)

(72) Inventors: Hongyu ZHANG, Beijing (CN); Chengwei WANG, Beijing (CN); Miao ZHANG, Beijing (CN); Guangtao FAN,, Beijing (CN); Xiaohui ZHANG, Beijing (CN)

(73) Assignee: RDA Microelectronics (Beijing) Co., Ltd., Beijing (CN)

(21) Appl. No.: 18/020,920

(22) PCT Filed: Aug. 6, 2021
(86) PCT No.: PCT/CN2021/111230

§ 371 Date: Feb. 10, 2023

(30) Foreign Application Priority Data
Aug. 10, 2020 (CN) 202010797979.5

(51) Int. Cl. H04W 8/18; H04W 48/16

(52) U.S. Cl. CPC H04W 8/183; H04W 48/16; H04W 88/06

(57) ABSTRACT

A terminal device is provided including: at least one card slot, configured to set a user identifying module; and a baseband processing chip, connected to the at least one card slot, where the baseband processing chip includes: a controlling module, configured to control selection and switching of at least two network modes; at least two communication protocol processing modules, respectively configured to perform camping on network for their corresponding network modes; a resource managing module, configured to manage resources of the baseband processing module and the radio frequency module used by the at least two network modes; a baseband processing module, configured to process baseband signals respectively corresponding to the at least two network modes; and a radio frequency module, configured to process radio frequency signals respectively corresponding to the at least two network modes.

### CROSS-REFERENCE TO RELATED APPLICATIONS

This application is a national stage of International Application No. PCT/CN2021/111230, filed on Aug. 6, 2021, which claims priority to Chinese Patent Application No. 202010797979.5, filed on Aug. 10, 2020, both of which are hereby incorporated by reference in their entireties.

### TECHNICAL FIELD

The present disclosure relates to the field of communication technology, in particular to a terminal device and a chip.

### BACKGROUND

Narrow band internet of things (NB-IoT) is an emerging technology in the field of IoT, which is characterized by low cost and low power consumption to support the cellular data connection of devices with high standby time requirements in wide area network. However, NB-IoT has not achieved full coverage in some areas and does not support some voice services.

### SUMMARY

The present disclosure provides a terminal device and a chip.

In the first aspect, the present disclosure provides a terminal device, including:

at least one card slot and a baseband processing chip connected to the at least one card slot; the baseband processing chip includes a controlling module, at least two communication protocol processing modules, a resource managing module, a baseband processing module and a radio frequency module;

where the card slot is configured to set a user identifying module; the controlling module is configured to control selection and switching of at least two network modes;

the communication protocol processing modules are configured to perform camping on network for the at least two network modes;

the resource managing module is configured to manage resources of the baseband processing module and the radio frequency module used by the at least two network modes;

the baseband processing module is configured to process baseband signals respectively corresponding to the at least two network modes;

the radio frequency module is configured to process radio frequency signals respectively corresponding to the at least two network modes.

In the second aspect, the present disclosure provides a chip, including: a controlling module, at least two communication protocol processing modules, a resource managing module, a baseband processing module and a radio frequency module;

where the controlling module is configured to control selection and switching of at least two network modes;

the communication protocol processing modules are configured to perform camping on network for the at least two network modes;

the resource managing module is configured to manage resources of the baseband processing module and the radio frequency module used by the at least two network modes;

the baseband processing module is configured to process baseband signals respectively corresponding to at least two network modes;

the radio frequency module is configured to process radio frequency signals respectively corresponding to the at least two network modes.

### BRIEF DESCRIPTION OF DRAWINGS

The drawings herein are incorporated into and form part of the specification, show embodiments that comply with the present disclosure and are used in conjunction with the specification to explain the principle of the present disclosure.

FIG. 1 is a network architecture diagram provided by an embodiment of the present disclosure.

FIG. 2 is a structure diagram of an embodiment of the terminal device provided in the present disclosure.

FIG. 3 is a structure diagram of another embodiment of the terminal device provided in the present disclosure.

FIG. 4 is a flow diagram of an embodiment provided in the present disclosure.

FIG. 5 is a principle diagram of an embodiment provided in the present disclosure.

The explicit embodiments of the present disclosure are shown by the drawings attached above and are described in more detail later. These drawings and descriptions are not intended to limit the scope of the present disclosure in any way, but rather to illustrate the concept of the present disclosure for skilled person in the field by referring to specific embodiments.

### DESCRIPTION OF EMBODIMENTS

Illustrative embodiments are described in detail here, as exemplified in the attached drawings. The description below relates to attached drawings, the same numbers in different attached drawings indicate the same or similar elements unless otherwise indicated. The implementations described in the following exemplary embodiments do not represent all implementations consistent with the present disclosure. Rather, they are merely examples of apparatuses and methods that are consistent with some aspects of the present disclosure as detailed in the attached claims.

The terms “includes” and “has” and any variation thereof in the specification and the claims and the drawings of the present disclosure are intended to cover non-exclusive inclusion. For example, a process, method, system, product, or device containing a series of steps or units is not limited to the steps or units listed, but optionally further includes steps or units not listed, or optionally further includes other steps or units inherent to these process, method, product or device.

First of all, the terms and application scenarios involved in the present disclosure are introduced:

Terminal device in the embodiments of the present disclosure may refer to various forms of user equipment (UE), access terminals, user units, user stations, mobile radio stations, mobile stations (MS), remote stations, remote terminals, mobile equipment, user terminal, terminal equipment, wireless communication device, user agent or user apparatus. The terminal device can also be cellular phone, cordless phone, Session Initiation Protocol (SIP) phone, Wireless Local Loop (WLL) station, Personal Digital Assistant (PDA), handheld device with wireless communication capability, computing device or other processing devices connected to wireless modem, vehicle mounted device, wearable device, terminal device in the future 5G Network or terminal device in the future evolving Public Land Mobile Network (PLMN) and so on, which are not limited by the embodiments of the present disclosure.

In addition, the network device involved in the present disclosure may be Global System of Mobile communication (GSM) or Base Transceiver Station (BTS) in Code Division Multiple Access (CDMA), or NodeB (NB) in Wideband Code Division Multiple Access (WCDMA), evolved NodeB (eNB) in Long Term Evolution (LTE) or evolved NodeB in evolved Long Term Evolution (eLTE), or next generation-evolved NodeB (ng-eNB), Access Point (AP) or relay station in Wireless Local Area Network (WLAN), generation NodeB (gNB) in 5G New Radio (NR), or access device in future communication network, etc., which is not limited here.

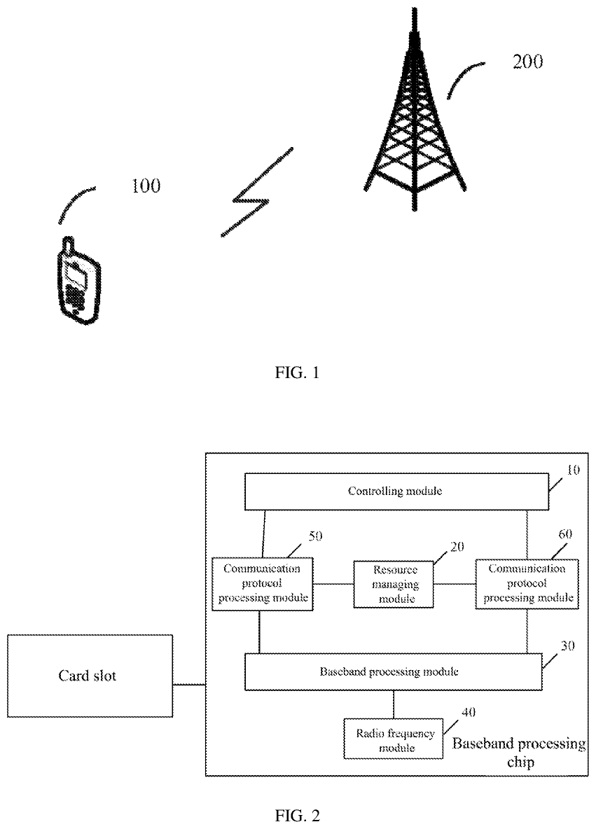

FIG. 1 is a network architecture diagram provided by an embodiment of the present disclosure, the technical solution provided in the present disclosure is based on the network architecture as shown in FIG. 1, where the network architecture includes at least one terminal device 100 communicating with network device 200 through a wireless interface. For clarity, only one terminal device and one network device are shown in FIG. 1.

NB-IoT is an emerging technology in the field of Internet of Things (IoT). It is characterized by low cost and low power consumption to support the cellular data connection of devices with high standby time requirements in Wide Area Network (WAN). NB-IoT does not have full coverage in some areas and does not support some voice services.

In contrast, GSM network, as a mature communication technology, has been widely used in the remote control scenario of the Internet of Things in recent years to meet the demands of different market segments. First, 2G technology is very mature, and it has been used in various scenarios that require remote control. After years of operation and accumulation by operators, supporting base stations are distributed all over the country, and GSM device communication network can be realized in most areas. Second, GSM network can provide some voice service using a wide range of base stations. Third, for GSM as a mature technology, the advantage of chip cost is also very significant.

Therefore, in the process of research, the inventor found that the mature GSM communication technology and NB-IoT communication technology can be combined to meet the demands of users.

If a set of GSM baseband chips and a set of NB-IoT baseband chips are pieced together to realize dual-mode, the integration degree is low and the module area is large. Therefore, a terminal device with high integration degree will be provided in the embodiments of the present disclosure. One baseband processing chip supports at least two communication modes, that is, at least two network modes, thereby multiple combinations and automatic switching of multiple communication modes can be realized to meet the demands of users for multiple mobile communications.

In an embodiment, the terminal device has both GSM communication mode and NB-IoT communication mode, and the combination and automatic switching of these two communication modes can be realized.

The following are specific embodiments to explain the technical solutions of the present disclosure in detail. The following specific embodiments may be combined with each other, and the same or similar concepts or processes may not be repeated in some embodiments.

FIG. 2 is a structure diagram of an embodiment of the terminal device provided in the present disclosure. As shown in FIG. 2, the terminal device provided in the present embodiment includes:

at least one card slot and a baseband processing chip connected to the at least one card slot; the baseband processing chip includes a controlling module 10, a resource managing module 20, a baseband processing module 30, a radio frequency module 40 and at least two communication protocol processing modules (50 and 60); where the card slot is configured to set a user identifying module; the controlling module 10 is configured to control selection and switching of at least two network modes;

the respective communication protocol processing modules are respectively configured to perform camping on network for their corresponding network modes;

the resource managing module 20 is configured to manage resources of the baseband processing module and the radio frequency module used by the at least two network modes;

the baseband processing module 30 is configured to process baseband signals respectively corresponding to at least two network modes;

the radio frequency module 40 is configured to process radio frequency signals respectively corresponding to the at least two network modes.

Specifically, the embodiments of the present disclosure use a set of baseband processing chips to realize the combination and free switching of at least two communication modes (namely, network mode), which supplements each other and has the advantages of strong practicability, low cost and small chip area.

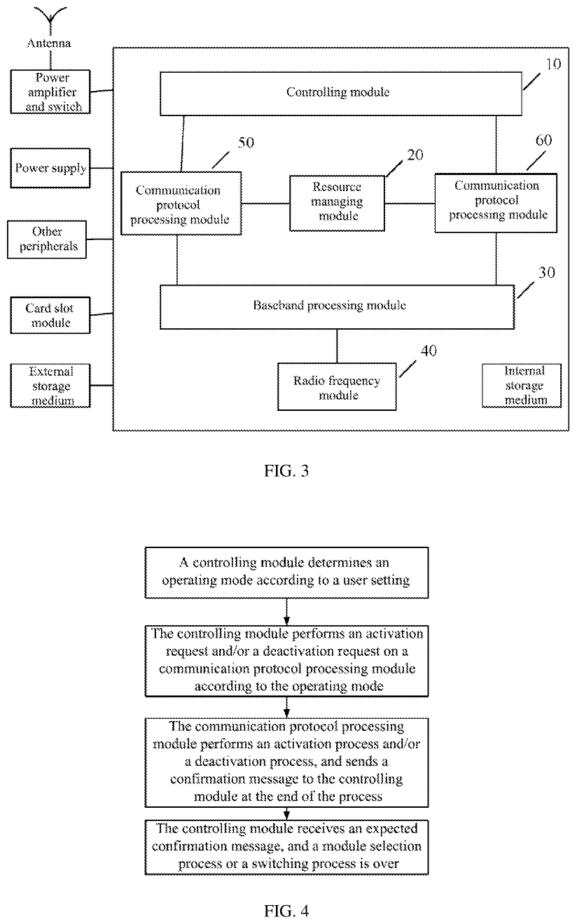

The terminal device includes a baseband processing chip and at least one card slot for installing the user identifying module, as shown in FIG. 3. The terminal device may also include a power supply, power amplifier, antenna, storage medium, and other peripherals, etc.

A user identifying module supports multiple network modes, or multiple user identifying modules support their respectively corresponding network modes, which is not limited in the present disclosure. For example, a user identifying module supports both GSM network mode and NB-IOT network mode at the same time, or two user identifying modules can support GSM network mode and NB-IOT network mode respectively.

The baseband processing chip includes a controlling module 10, a resource managing module 20, a baseband processing module 30, and a radio frequency module 40.

The controlling module 10 is configured to select the network mode and control the switching of the network mode, for example, to select the network mode and control the switching of the network mode according to at least one of the following: user setting, network status, and application requirement.

In one embodiment, the controlling module 10 can further receive user setting including preferred network mode setting, etc.

For each network mode, it respectively corresponds to a communication protocol processing module. The communication protocol processing module 50 is configured to perform the camping on network for the network mode, and further to pass through service bearer of the corresponding network mode. FIG. 2 takes two communication protocol processing modules as an example.

The resource managing module 20 is configured to manage resources of the baseband processing module and the radio frequency module used by the at least two network modes.

For example, the resource managing module 20 receives a baseband processing module usage request from the communication protocol processing module, makes a decision if there are conflicting usage requests, and ensures that only one communication protocol processing module uses the baseband processing module at the same time.

The baseband processing module 30 follows the wireless communication protocol standards of at least two network modes for baseband signal processing, and the baseband processing module has the baseband processing capability of more than two wireless communication protocols.

The radio frequency module 40 follows the communication protocol radio frequency standards of at least two network modes for receiving and sending radio frequency signal. The radio frequency module uses a set of hardware and has the radio frequency processing capability of more than two wireless communication protocols.

One network mode of the at least two network modes can be: any one of NB-IOT, enhanced Machine-Type Communication (EMTC), 5G IOT; where another option could be any one of GSM, General Packet Radio Service (GRPS), Enhanced Data Rate for GSM Evolution (EDGE), or other mobile communication network modes in addition to the IOT network mode.

The terminal device in the present embodiment realizes the terminal device that supports at least two network modes through a baseband processing chip, where the at least two network modes can be freely combined and switched, be supplemented each other, and the chip integration degree is high, practicability is strong, and cost is low.

In one embodiment, as shown in FIG. 4, the controlling module is specifically configured to:

control communication protocol processing modules respectively corresponding to the at least two network mode to perform activation processing and/or deactivation processing on the network mode according to an operating mode selected by a user.

The operating mode includes: single-mode single-standby under any one network mode; multiple-mode and multiple-standby under at least two network modes (including dual-mode dual-standby under two network modes); any one network mode is in priority, and other network modes are used as supplement; flight mode.

It controls communication protocol processing modules respectively corresponding to the at least two network modes to perform activation processing and/or deactivation processing on the network mode according to the operating mode selected by the user, that is, it performs the camping on network for the respectively corresponding network mode.

In an embodiment, as shown in FIG. 4, the at least two network modes include a first network mode and a second network mode, and the controlling module 10 is specifically configured to:

send an activation request to a communication protocol processing module corresponding to any one network mode for activating the any one network mode in case of that the operating mode is single-mode single-standby under the any one network mode of the at least two network modes; or

send an activation request to communication protocol processing modules respectively corresponding to the first network mode and the second network mode respectively in case of that the operating mode is dual-mode dual-standby under the first network mode and the second network mode; or

send an activation request to a communication protocol processing module corresponding to any one network mode in case of that the operating mode is that the any one network mode of the first network mode and the second network mode is in priority; or

send a deactivation request to communication protocol processing modules respectively corresponding to the first network mode and the second network mode respectively for deactivating the first network mode and the second network mode in case of that the operating mode is flight mode.

Specifically, if the operating mode is single-mode single-standby, it is assumed that it is single-mode single-standby under the first network mode (the principle of single-mode single-standby under the second network mode is similar), then it determines whether the first network mode is in activated state. If not, it sends the activation request to the communication protocol processing module corresponding to the first network mode for activating the first network mode. If the controlling module receives the activation confirmation returned by the communication protocol processing module, the camping on network for the first network mode is succeeded.

Before activating the first network mode, it determines whether the second network mode is in activated state. If so, it sends the deactivation request to the communication protocol processing module corresponding to the second network mode for deactivating the second network mode.

If the operating mode is dual-mode dual-standby under the first network mode and the second network mode, it sends the activation request to the communication protocol processing module respectively corresponding to the first network mode and the second network mode respectively. If the controlling module receives the activation confirmation returned by the communication protocol processing modules respectively corresponding to the first network mode and the second network mode, the camping on network for the first network mode and the second network mode is succeeded.

If the operating mode is that the any one network mode of the first network mode and the second network mode is in priority, it sends the activation request to the communication protocol processing module corresponding to the any one network mode, and if the other network mode is in activated state, it sends the deactivation request. It is similar to the single-mode single-standby.

If the operating mode is in flight mode, it sends the deactivation request to the communication protocol processing modules respectively corresponding to the first network mode and the second network mode respectively for deactivating the first network mode and the second network mode.

After the controlling modules receive the deactivation confirmations from their respectively corresponding communication protocol processing modules, the terminal device enters flight mode.

In the above operating modes, under other operating modes except flight mode, if the controlling module receives a user request for performing the service in the circuit switching domain, such as voice call, the controlling module initiates an activation request of the communication protocol processing module (such as communication protocol processing module 50), and after the activation is successful, it performs the service in the circuit switching domain. After the service ends, it deactivates the communication protocol processing module 50 as required based on the setting of the operating mode.

In an embodiment, in case of that the operating mode is dual-mode dual-standby under the first network mode and the second network mode, the controlling module is specifically configured to:

send an activation request for circuit switching domain to the communication protocol processing module corresponding to the first network mode;

send an activation request for data exchange domain to the communication protocol processing module corresponding to the second network mode.

Specifically, it is assumed that the first network mode supports the service in the circuit switching domain, such as voice service, the first network mode only performs the registration on the circuit switching domain, and the second network mode only performs the registration on the data switching domain.

The controlling module sends the activation request for circuit switching domain to the communication protocol processing module corresponding to the first network mode, and the controlling module sends the activation request for data switching domain to the communication protocol processing module corresponding to the second network mode. It waits for receiving the activation result of the communication protocol processing module corresponding to the first network mode and the communication protocol processing module corresponding to the second network mode, and the network mode selection ends.

It is required to be noted here that whether to achieve the same one user whose are in dual network standby of circuit switching domain and data switching domain also depends on the mobile operator's strategy.

In an embodiment, in case of that the operating mode is in the first network mode, the controlling module is further configured to:

determine whether it is required for performing network searching on the second network mode according to a network condition of the first network mode;

based on the determination that it is required for performing network searching on the second network mode, send a network searching request to the communication protocol processing module corresponding to the second network mode;

determine whether to switch from the first network mode to the second network mode according to a network searching result of the communication protocol processing module corresponding to the second network mode; the network searching result includes a network condition of the second network mode;

based on the determination that to switch from the first network mode to the second network mode, send the deactivation request to the communication protocol processing module corresponding to the first network mode, and send the activation request to the communication protocol processing module corresponding to the second network mode.

Specifically, the initial state: the operating mode of the terminal device is that the first network mode is in priority, and the second network mode is used as supplement.

The controlling module determines whether to need to request for performing the network searching attempt of the second network mode according to the status of the first network mode, such as the network quality report. After determining the need to request for performing the network searching attempt of the second network mode, it sends a network searching request to the communication protocol processing module corresponding to the second network mode to request for the communication protocol processing module corresponding to the second network mode to perform the network searching.

If the search result returned by the communication protocol processing module corresponding to the second network mode does not meet the camping on requirement of the controlling module, the controlling module waits for a period of time and periodically sends a network searching request to the communication protocol processing module corresponding to the second network mode again, until the state of the first network mode becomes better, or a network searching result of the communication protocol processing module corresponding to the second network mode meets the camping on requirement of the controlling module.

For example, the camping on requirement: the signal intensity in the network mode is greater than the preset threshold and so on.

If a network searching result of the communication protocol processing module corresponding to the second network mode meets the camping on requirement of the controlling module, the controlling module sends the deactivation request to the communication protocol processing module corresponding to the first network mode. After the deactivation is complete, the controlling module sends the activation request to the communication protocol processing module corresponding to the second network mode. After the activation is completed, the automatically switching from the preferred network mode to the supplementary network mode is completed.

In an embodiment, the controlling module is further configured to:

send a network searching request to the communication protocol processing module corresponding to the first network mode after camping on the second network mode is succeeded;

determine whether to send the deactivation request to the communication protocol processing module corresponding to the second network mode according to a network searching result of the communication protocol processing module corresponding to the first network mode; the network searching result includes a network condition of the first network mode;

based on the determination that to send the deactivation request to the communication protocol processing module corresponding to the second network mode, send the deactivation request to the communication protocol processing module corresponding to the second network mode, and send the activation request to the communication protocol processing module corresponding to the first network mode after the completion of deactivation of the communication protocol processing module corresponding to the second network mode.

Specifically, after the switching is completed, the controlling module will periodically initiate the network searching request of the first network mode to the communication protocol processing module corresponding to the first network mode until the search result of the communication protocol processing module corresponding to the first network mode meets the camping on requirement of the controlling module, and the controlling module will initiate the deactivation request to the communication protocol processing module corresponding to the second network mode, and after the deactivation is completed, send the activation request to the communication protocol processing module corresponding to the first network mode.

Thus, the automatic switching process that the preferred network mode is switched to the supplementary network mode and the supplementary network mode is switched back again to the preferred network mode is completed. The whole process does not require user participation, and the service of another network mode is not interrupted during the process of trying the network searching.

The above implementation realizes the free combination and switching of the two network modes, which supplement each other and have the advantages of strong practicability, low cost and high chip integration. For example, the free combination and switching of the GSM communication mode and NB-IoT communication mode are realized, which gives full play to the maximum advantage of these two communication modes, can better meet the demands of users, and avoid the problem that the user cannot perform normal communication when one of the communication network signals is unstable or the network coverage is incomplete.

During the above network mode automatic switching process, as well as user-initiated service process of circuit switching domain and data switching domain, there is a scenario that the first network mode and the second network mode require baseband service processing at the same time. In this scenario, the communication protocol processing modules respectively corresponding to the first network mode and the second network mode are required for using baseband processing module and radio frequency module. However, there is only one set of baseband processing module and one set of radio frequency module in the baseband processing chip of the embodiments of the present disclosure. In order to avoid resource conflict caused by baseband processing module and radio frequency module simultaneously used by the communication protocol processing modules respectively corresponding to the first network mode and the second network mode, a resource managing module is introduced in the embodiments of the present disclosure. The purpose and operating principle of the resource managing module are described as follows:

the communication protocol processing module is further configured to:

send a resource usage request to the resource managing module, where the resource usage request includes: resource usage reason, usage time information;

the resource managing module is configured to return a resource acquisition result to the communication protocol processing module according to a resource usage situation and a priority of the resource usage reason when a resource acquisition request sent by the communication protocol processing module is received.

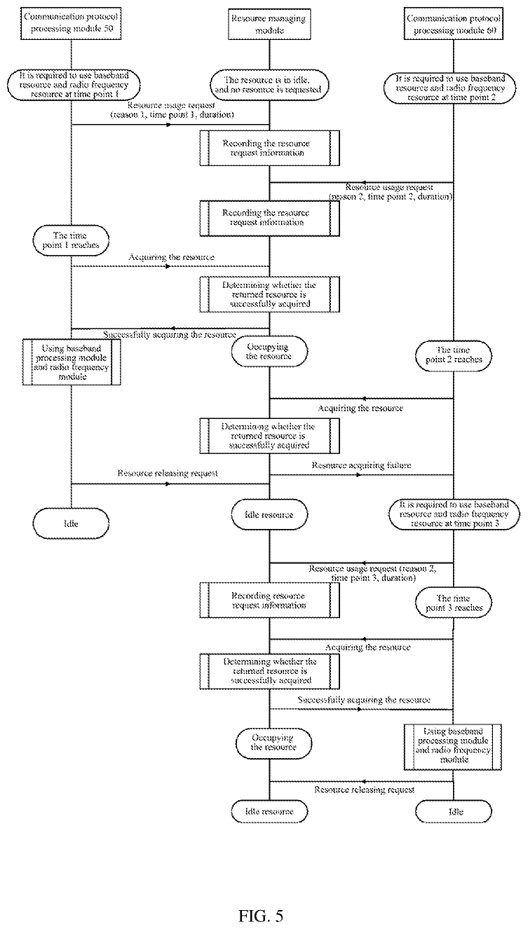

Specifically, as shown in FIG. 5, when it is required for using the resources of the baseband processing module and radio frequency module, it is required for requesting for resources from the resource managing module in advance, and informing the reason for requesting for resources and the time information of using resources, such as the start time and duration of using resources, or the start time and end time of using resources.

The resource managing module records resource requests of respective communication protocol processing module.

When the resource usage time reaches, respective communication protocol processing module sends the resource acquisition request to the resource managing module.

The resource managing module determines whether to reject or accept the resource acquisition request according to the resource usage situation (whether it is idle or occupied) and the priority of the resource usage reason, and returns the result to the communication protocol processing module that is requested.

The module that obtains resource successfully uses baseband resource and radio frequency resource. When the resources are used up, it releases the resources and notifies the resource managing module that the resources have been released, that is, the resources are free.

The communication protocol processing module that fails to acquire resources can request for resources at the new time point again.

Therefore, the resource managing module can realize the coexistence of the two network modes in the situation that the high-priority service is in priority.

In the above implementation, the resource managing module realizes the free combination and switching of two network modes on the basis of baseband processing chip including one baseband module resource and one radio frequency module resource, which supplement each other, avoid resource conflict, and avoid the problem that users cannot communicate normally when one of the communication network signals is unstable or the network coverage is incomplete. It can better meet the demands of users.

The embodiments of the present disclosure further provide a chip, as shown in FIG. 2, which includes:

a controlling module, at least two communication protocol processing modules, a resource managing module, a baseband processing module and a radio frequency module;

where the controlling module is configured to control selection and switching of at least two network modes;

the respective communication protocol processing modules are respectively configured to perform camping on network for their corresponding network modes;

the resource managing module is configured to manage resources of the baseband processing module and the radio frequency module used by the at least two network modes;

the baseband processing module is configured to process baseband signals respectively corresponding to at least two network modes;

the radio frequency module is configured to process radio frequency signals respectively corresponding to the at least two network modes.

In one possible implementation, the controlling module is specifically configured to:

control communication protocol processing modules respectively corresponding to the at least two network mode to perform activation processing and/or deactivation processing on the network mode according to an operating mode selected by a user.

In one possible implementation, the at least two network modes include a first network mode and a second network mode, and the controlling module is specifically configured to:

send an activation request to a communication protocol processing module corresponding to any one network mode for activating the any one network mode in case of that the operating mode is single-mode single-standby under the any one network mode of the at least two network modes; or

send an activation request to communication protocol processing modules respectively corresponding to the first network mode and the second network mode respectively in case of that the operating mode is dual-mode dual-standby under the first network mode and the second network mode; or

send an activation request to a communication protocol processing module corresponding to any one network mode in case of that the operating mode is that the any one network mode of the first network mode and the second network mode is in priority; or

send a deactivation request to communication protocol processing modules respectively corresponding to the first network mode and the second network mode respectively for deactivating the first network mode and the second network mode in case of that the operating mode is flight mode.

In one possible implementation, in case of that the operating mode is dual-mode dual-standby under the first network mode and the second network mode, the controlling module is specifically configured to:

send an activation request for circuit switching domain to the communication protocol processing module corresponding to the first network mode;

send an activation request for data exchange domain to the communication protocol processing module corresponding to the second network mode.

In one possible implementation, in case of that the operating mode is that the first network mode is in priority, the controlling module is further configured to:

determine whether it is required for performing network searching on the second network mode according to a network condition of the first network mode;

based on the determination that it is required for performing network searching on the second network mode, send a network searching request to the communication protocol processing module corresponding to the second network mode;

determine whether to switch from the first network mode to the second network mode according to a network searching result of the communication protocol processing module corresponding to the second network mode; the network searching result includes a network condition of the second network mode;

based on the determination that to switch from the first network mode to the second network mode, send the deactivation request to the communication protocol processing module corresponding to the first network mode, and send the activation request to the communication protocol processing module corresponding to the second network mode.

In one possible implementation, the controlling module is further configured to:

send a network searching request to the communication protocol processing module corresponding to the first network mode after camping on the second network mode is succeeded;

determine whether to send the deactivation request to the communication protocol processing module corresponding to the second network mode according to a network searching result of the communication protocol processing module corresponding to the first network mode; the network searching result includes a network condition of the first network mode;

based on the determination that to send the deactivation request to the communication protocol processing module corresponding to the second network mode, send the deactivation request to the communication protocol processing module corresponding to the second network mode, and send the activation request to the communication protocol processing module corresponding to the first network mode after the completion of deactivation of the communication protocol processing module corresponding to the second network mode.

In one possible implementation, the communication protocol processing module is further configured to:

send a resource usage request to the resource managing module, where the resource usage request includes: resource usage reason, usage time information;

the resource managing module is configured to return a resource acquisition result to the communication protocol processing module according to a resource usage situation and a priority of the resource usage reason when a resource acquisition request sent by the communication protocol processing module is received.

In one possible implementation, the at least two network modes include: a NB-IoT mode, and other cellular mobile communication network modes other than the NB-IoT mode.

The realization principle and technical effect of the apparatus in the present embodiments is similar to that of the terminal device in the above embodiments, which can be referred to any of the above embodiments and will not be repeated here.

In the first aspect, the present disclosure provides a terminal device, including:

at least one card slot and a baseband processing chip connected to the at least one card slot; the baseband processing chip includes a controlling module, at least two communication protocol processing modules, a resource managing module, a baseband processing module and a radio frequency module;

where the card slot is configured to set a user identifying module; the controlling module is configured to control selection and switching of at least two network modes;

the communication protocol processing modules are configured to perform camping on network for the at least two network modes;

the resource managing module is configured to manage resources of the baseband processing module and the radio frequency module used by the at least two network modes;

the baseband processing module is configured to process baseband signals respectively corresponding to the at least two network modes;

the radio frequency module is configured to process radio frequency signals respectively corresponding to the at least two network modes.

In one possible implementation, the controlling module is specifically configured to:

control communication protocol processing modules respectively corresponding to the at least two network mode to perform activation processing and/or deactivation processing on the network mode according to an operating mode selected by a user.

In one possible implementation, the at least two network modes include a first network mode and a second network mode, and the controlling module is specifically configured to:

send an activation request to a communication protocol processing module corresponding to any one network mode for activating the any one network mode in case of that the operating mode is single-mode single-standby under the any one network mode of the at least two network modes; or

send an activation request to communication protocol processing modules respectively corresponding to the first network mode and the second network mode respectively in case of that the operating mode is dual-mode dual-standby under the first network mode and the second network mode; or

send an activation request to a communication protocol processing module corresponding to any one network mode in case of that the operating mode is that the any one network mode of the first network mode and the second network mode is in priority; or

send a deactivation request to communication protocol processing modules respectively corresponding to the first network mode and the second network mode respectively for deactivating the first network mode and the second network mode in case of that the operating mode is flight mode.

In one possible implementation, in case of that the operating mode is dual-mode dual-standby under the first network mode and the second network mode, the controlling module is specifically configured to:

send an activation request for circuit switching domain to the communication protocol processing module corresponding to the first network mode;

send an activation request for data exchange domain to the communication protocol processing module corresponding to the second network mode.

In one possible implementation, in case of that the operating mode is that the first network mode is in priority, the controlling module is further configured to:

determine whether it is required for performing network searching on the second network mode according to a network condition of the first network mode;

based on the determination that it is required for performing network searching on the second network mode, send a network searching request to the communication protocol processing module corresponding to the second network mode;

determine whether to switch from the first network mode to the second network mode according to a network searching result of the communication protocol processing module corresponding to the second network mode; the network searching result includes a network condition of the second network mode;

based on the determination that to switch from the first network mode to the second network mode, send the deactivation request to the communication protocol processing module corresponding to the first network mode, and send the activation request to the communication protocol processing module corresponding to the second network mode.

In one possible implementation, the controlling module is further configured to:

send a network searching request to the communication protocol processing module corresponding to the first network mode after camping on the second network mode is succeeded;

determine whether to send the deactivation request to the communication protocol processing module corresponding to the second network mode according to a network searching result of the communication protocol processing module corresponding to the first network mode; the network searching result includes a network condition of the first network mode;

based on the determination that to send the deactivation request to the communication protocol processing module corresponding to the second network mode, send the deactivation request to the communication protocol processing module corresponding to the second network mode, and send the activation request to the communication protocol processing module corresponding to the first network mode after the completion of deactivation of the communication protocol processing module corresponding to the second network mode.

In one possible implementation, the communication protocol processing module is further configured to:

send a resource usage request to the resource managing module, where the resource usage request includes: resource usage reason, usage time information;

the resource managing module is configured to return a resource acquisition result to the communication protocol processing module according to a resource usage situation and a priority of the resource usage reason when a resource acquisition request sent by the communication protocol processing module is received.

In one possible implementation, the at least two network modes include: a Narrow Band Internet of Things (NB-IoT) mode, and other cellular mobile communication network modes other than the NB-IoT mode.

In the second aspect, the present disclosure provides a chip, including:

a controlling module, at least two communication protocol processing modules, a resource managing module, a baseband processing module and a radio frequency module;

where the controlling module is configured to control selection and switching of at least two network modes;

the communication protocol processing modules are configured to perform camping on network for the at least two network modes;

the resource managing module is configured to manage resources of the baseband processing module and the radio frequency module used by the at least two network modes;

the baseband processing module is configured to process baseband signals respectively corresponding to at least two network modes;

the radio frequency module is configured to process radio frequency signals respectively corresponding to the at least two network modes.

In one possible implementation, the at least two network modes include a first network mode and a second network mode, and the controlling module is specifically configured to:

send an activation request to a communication protocol processing module corresponding to any one network mode for activating the any one network mode in case of that the operating mode is single-mode single-standby under the any one network mode of the at least two network modes; or

send an activation request to communication protocol processing modules respectively corresponding to the first network mode and the second network mode respectively in case of that the operating mode is dual-mode dual-standby under the first network mode and the second network mode; or

send an activation request to a communication protocol processing module corresponding to any one network mode in case of that the operating mode is that the any one network mode of the first network mode and the second network mode is in priority; or

send a deactivation request to communication protocol processing modules respectively corresponding to the first network mode and the second network mode respectively for deactivating the first network mode and the second network mode in case of that the operating mode is flight mode.

In one possible implementation, in case of that the operating mode is that the first network mode is in priority, the controlling module is further configured to:

determine whether it is required for performing network searching on the second network mode according to a network condition of the first network mode;

based on the determination that it is required for performing network searching on the second network mode, send a network searching request to the communication protocol processing module corresponding to the second network mode;

determine whether to switch from the first network mode to the second network mode according to a network searching result of the communication protocol processing module corresponding to the second network mode; the network searching result includes a network condition of the second network mode;

based on the determination that to switch from the first network mode to the second network mode, send the deactivation request to the communication protocol processing module corresponding to the first network mode, and send the activation request to the communication protocol processing module corresponding to the second network mode.

In one possible implementation, the communication protocol processing module is further configured to:

send a resource usage request to the resource managing module, where the resource usage request includes: resource usage reason, usage time information;

the resource managing module is configured to return a resource acquisition result to the communication protocol processing module according to a resource usage situation and a priority of the resource usage reason when a resource acquisition request sent by the communication protocol processing module is received.

After considering the specification and practicing the disclosure disclosed herein, a person skilled in the field will readily think of other implementations of the present disclosure. The present disclosure is intended to cover any variation, use or adaptive change of the present disclosure that follows the general principles of the present disclosure and includes the common knowledge or customary technical means in the present field of technology not disclosed by the present disclosure. The specification and embodiments are deemed to be of an exemplary nature only, and the true scope and spirit of the present disclosure are indicated by the claims below.

It should be understood that the present disclosure is not limited to the precise structure already described above and shown in the attached drawings and performs various modifications and changes without deviating from its scope. The scope of the present disclosure is limited only by the attached claim.

What is claimed is:

1. A terminal device, comprising:
at least one card slot and a baseband processing chip connected to the at least one card slot; the baseband processing chip comprises a controlling module, at least two communication protocol processing modules, a resource managing module, a baseband processing module and a radio frequency module;
wherein the card slot is configured to set a user identifying module; the controlling module is configured to control selection and switching of at least two network modes;
the respective communication protocol processing modules are respectively configured to perform camping on network for their corresponding network modes;
the resource managing module is configured to manage resources of the baseband processing module and the radio frequency module used by the at least two network modes;
the baseband processing module is configured to process baseband signals respectively corresponding to the at least two network modes;
the radio frequency module is configured to process radio frequency signals respectively corresponding to the at least two network modes.

2. The terminal device according to claim 1, wherein the controlling module is specifically configured to:
control communication protocol processing modules respectively corresponding to the at least two network mode to perform activation processing and/or deactivation processing on the network mode according to an operating mode selected by a user.

3. The terminal device according to claim 2, wherein the at least two network mode comprises a first network mode and a second network mode, and the controlling module is specifically configured to:
send an activation request to a communication protocol processing module corresponding to any one network mode for activating the any one network mode in case of that the operating mode is single-mode single-standby under the any one network mode of the at least two network modes; or
send an activation request to communication protocol processing modules respectively corresponding to the first network mode and the second network mode respectively in case of that the operating mode is dual-mode dual-standby under the first network mode and the second network mode; or
send an activation request to a communication protocol processing module corresponding to any one network mode in case of that the operating mode is that the any one network mode of the first network mode and the second network mode is in priority; or
send a deactivation request to communication protocol processing modules respectively corresponding to the first network mode and the second network mode respectively for deactivating the first network mode and the second network mode in case of that the operating mode is flight mode.

4. The terminal device according to claim 3, wherein in case of that the operating mode is dual-mode dual-standby under the first network mode and the second network mode, the controlling module is specifically configured to:
send an activation request for circuit switching domain to the communication protocol processing module corresponding to the first network mode;
send an activation request for data exchange domain to the communication protocol processing module corresponding to the second network mode.

5. The terminal device according to claim 3, wherein in case of that the operating mode is that the first network mode is in priority, the controlling module is further configured to:
determine whether it is required for performing network searching on the second network mode according to a network condition of the first network mode;
based on the determination that is required for performing network searching on the second network mode, send a network searching request to the communication protocol processing module corresponding to the second network mode;
determine whether to switch from the first network mode to the second network mode according to a network searching result of the communication protocol processing module corresponding to the second network mode; the network searching result comprises a network condition of the second network mode;
based on the determination that to switch from the first network mode to the second network mode, send the deactivation request to the communication protocol processing module corresponding to the first network mode, and send the activation request to the communication protocol processing module corresponding to the second network mode.

6. The terminal device according to claim 4, wherein then the operating mode is that the first network mode is in priority, the controlling module is further configured to:
determine whether it is required for performing network searching on the second network mode according to a network condition of the first network mode;
based on the determination that is required for performing network searching on the second network mode, send a network searching request to the communication protocol processing module corresponding to the second network mode;
determine whether to switch from the first network mode to the second network mode according to a network searching result of the communication protocol processing module corresponding to the second network mode, the network searching result comprises a network condition of the second network mode;
based on the determination that to switch from the first network mode to the second network mode, send the deactivation request to the communication protocol processing module corresponding to the first network mode, and send the activation request to the communication protocol processing module corresponding to the second network mode.

7. The terminal device according to claim 5, wherein the controlling module is further configured to:
send a network searching request to the communication protocol processing module corresponding to the first network mode after camping on the second network mode is succeeded;
determine whether to send the deactivation request to the communication protocol processing module corresponding to the second network mode according to a network searching result of the communication protocol processing module corresponding to the first network mode; the network searching result comprises a network condition of the first network mode;
based on the determination that to send the deactivation request to the communication protocol processing module corresponding to the second network mode, send the deactivation request to the communication protocol processing module corresponding to the second network mode, and send the activation request to the communication protocol processing module corresponding to the first network mode after the completion of deactivation of the communication protocol processing module corresponding to the second network mode.

8. The terminal device according to claim 2, wherein the communication protocol processing module is further configured to:
send a resource usage request to the resource managing module, wherein the resource usage request comprises: resource usage reason, usage time information;
the resource managing module is configured to return a resource acquisition result to the communication protocol processing module according to a resource usage situation and a priority of the resource usage reason when a resource acquisition request sent by the communication protocol processing module is received.

9. The terminal device according to claim 1, wherein
the at least two network modes comprise: a Narrow Band Internet of Things (NB-IoT) mode, and other cellular mobile communication network modes other than the NB-IoT mode.

10. A chip, comprising:
a controlling module, at least two communication protocol processing modules, a resource managing module, a baseband processing module and a radio frequency module;
wherein the controlling module is configured to control selection and switching of at least two network modes;
the respective communication protocol processing modules are respectively configured to perform camping on network for their corresponding network modes;
the resource managing module is configured to manage resources of the baseband processing module and the radio frequency module used by the at least two network modes;
the baseband processing module is configured to process baseband signals respectively corresponding to at least two network modes;
the radio frequency module is configured to process radio frequency signals respectively corresponding to the at least two network modes.

11. The chip according to claim 10, wherein the at least two network mode comprises a first network mode and a second network mode, and the controlling module is specifically configured to:
send an activation request to a communication protocol processing module corresponding to any one network mode for activating the any one network mode in case of that the operating mode is single-mode single-standby under the any one network mode of the at least two network modes; or
send an activation request to communication protocol processing modules respectively corresponding to the first network mode and the second network mode respectively in case of that the operating mode is dual-mode dual-standby under the first network mode and the second network mode; or
send an activation request to a communication protocol processing module corresponding to any one network mode in case of that the operating mode is that the any one network mode of the first network mode and the second network mode is in priority; or
send a deactivation request to communication protocol processing modules respectively corresponding to the first network mode and the second network mode respectively for deactivating the first network mode and the second network mode in case of that the operating mode is flight mode.

12. The chip according to claim 11, wherein in case of that the operating mode is that the first network mode is in priority, the controlling module is further configured to:
determine whether it is required for performing network searching on the second network mode according to a network condition of the first network mode;
based on the determination that it is required for performing network searching on the second network mode, send a network searching request to the communication protocol processing module corresponding to the second network mode;
determine whether to switch from the first network mode to the second network mode according to a network searching result of the communication protocol processing module corresponding to the second network mode; the network searching result comprises a network condition of the second network mode;
based on the determination that to switch from the first network mode to the second network mode, send the deactivation request to the communication protocol processing module corresponding to the first network mode, and send the activation request to the communication protocol processing module corresponding to the second network mode.

13. The chip according to claim 11, wherein the communication protocol processing module is further configured to:
send a resource usage request to the resource managing module, wherein the resource usage request comprises: resource usage reason, usage time information;
the resource managing module is configured to return a resource acquisition result to the communication protocol processing module according to a resource usage situation and a priority of the resource usage reason when a resource acquisition request sent by the communication protocol processing module is received.
